(19) United States
(12) Patent Application Publication
(10) Pub. No.: US 2014/0007856 A1
(43) Pub. Date: Jan. 9, 2014

(54) INTER-CYLINDER AIR/FUEL RATIO VARIATION ABNORMALITY DETECTION APPARATUS AND METHOD FOR MULTICYLINDER INTERNAL COMBUSTION ENGINE

(71) Applicant: Kazuki Tsuruoka, Toyota-shi (JP)

(72) Inventor: Kazuki Tsuruoka, Toyota-shi (JP)

(73) Assignee: TOYOTA JIDOSHA KABUSHIKI KAISHA, Toyota-shi (JP)

(21) Appl. No.: 13/920,191

(22) Filed: Jun. 18, 2013

(30) Foreign Application Priority Data
Jul. 5, 2012 (JP) 2012-151575

(51) Int. Cl. F02D 41/00

(52) U.S. Cl. CPC F02D 41/00
USPC 123/704

(57) ABSTRACT

An inter-cylinder air/fuel ratio variation abnormality detection apparatus for a multicylinder internal combustion engine in accordance with the invention: detects a first parameter that represents revolution fluctuation of a cylinder of a plurality of cylinders of the engine, with respect to each cylinder; calculates, with respect to an unspecified cylinder, a second parameter as a sum of the first parameters of the cylinders other than the unspecified cylinder, and calculates the second parameter with respect to each cylinder; and detects an inter-cylinder air/fuel ratio variation abnormality based on the second parameter of each cylinder, and determines an abnormal cylinder that has the inter-cylinder air/fuel ratio variation abnormality.

### INCORPORATION BY REFERENCE

The disclosure of Japanese Patent Application No. 2012-151575 filed on Jul. 5, 2012 including the specification, drawings and abstract is incorporated herein by reference in its entirety.

### BACKGROUND OF THE INVENTION

1. Field of the Invention

The invention relates to an abnormality detection apparatus and an abnormality detection method for detecting inter-cylinder air/fuel ratio variation abnormality of a multicylinder internal combustion engine. More specifically, the invention relates to an abnormality detection apparatus and an abnormality detection method for a multicylinder internal combustion engine that are capable of detecting that the air/fuel ratio varies relatively greatly among the cylinders of the engine.

2. Description of Related Art

Generally, in an internal combustion engine provided with an exhaust emission control system that uses a catalyst, it is indispensable to control the mixing ratio of air to fuel in a mixture to be burned in the internal combustion engine, that is, the air/fuel ratio, in order to accomplish high-efficient removal of pollutants from exhaust gas through the use of the catalyst. The internal combustion engine, in order to control the air/fuel ratio, has an air/fuel ratio sensor in an exhaust passageway of an internal combustion engine. The internal combustion engine carries out such a feedback control as to make the air/fuel ratio detected by the air/fuel ratio sensor equal to a predetermined target air/fuel ratio.

Usually, in a multicylinder internal combustion engine, the air/fuel ratio control is performed by using equal or uniform control amounts for all the cylinders; therefore, despite the execution of the air/fuel feedback ratio control, the actual air/fuel ratio can vary among the cylinders. If the variation of the air/fuel ratio is of a small degree, the variation of the air/fuel ratio can be absorbed by the air/fuel ratio feedback control. Furthermore, pollutants in exhaust gas can be removed by the catalyst. Thus, small degrees of variation of the air/fuel ratio do not affect the exhaust emission, and thus do not lead to any particular problem.

However, if the air/fuel ratio greatly varies among the cylinders due to, for example, failure of one or more of the fuel injection systems of the individual cylinders, or the like, the exhaust emission deteriorates, and problems arise. It is desirable that such a large variation in the air/fuel ratio as to deteriorate the exhaust emission be detected as an abnormality. Particularly, in the case of the internal combustion engine for motor vehicles, it has been demanded that an inter-cylinder air/fuel ratio variation abnormality of the engine be detected in a vehicle-mounted state (so-called on-board diagnostics (OBD)), so that the vehicle can be prevented from traveling with deteriorated emission.

For example, in an apparatus described in Japanese Patent Application Publication No. 2010-112244 (JP 2010-112244 A), when it is determined that there is air/fuel ratio abnormality in a cylinder (or cylinders), the abnormal cylinder is specifically determined by shortening the fuel injection duration of each cylinder for which fuel is injected into the cylinder, by a predetermined amount of time at a time during a period until the cylinder with the air/fuel ratio abnormality has a misfire.

An existing method for detecting the inter-cylinder air/fuel ratio variation abnormality is a method in which a parameter that represents fluctuation in revolution of each cylinder is detected and is utilized.

If there occurs a lean deviation abnormality in which the air/fuel ratio of a cylinder is deviated to the lean side, the fluctuation in revolution of the abnormal cylinder becomes large or deteriorated, and the value of the parameter greatly changes to the large revolution fluctuation side. Hence, by monitoring the value of the parameter, it is possible to detect the lean deviation abnormality of a cylinder and therefore the inter-cylinder air/fuel ratio variation abnormality based on the lean deviation abnormality.

On the other hand, when there occurs a rich deviation abnormality in which the air/fuel ratio of a cylinder is deviated to the rich side, it is sometimes difficult to detect the air/fuel ratio variation abnormality through the use of the aforementioned parameter.

That is, while the torque produced by an internal combustion engine depends on the reaction of fuel and oxygen, increase in the amount of fuel merely results in fuel being in excess, and does not significantly affect fluctuation in revolution. Increase in the amount of fuel has strong effect on fluctuation in revolution only when the amount of fuel is increased beyond a rich limit. Hence, it sometimes happens that despite the use of the parameter that represents revolution fluctuation of each cylinder, it is difficult to detect the rich deviation abnormality.

### SUMMARY OF THE INVENTION

Accordingly, the invention provides an inter-cylinder air/fuel ratio variation abnormality detection apparatus for a multicylinder internal combustion engine which suitably detects the rich deviation abnormality of a cylinder by using a parameter that represents revolution fluctuation of each cylinder.

An inter-cylinder air/fuel ratio variation abnormality detection apparatus for a multicylinder internal combustion engine in accordance with a first aspect of the invention includes: a first parameter detection portion that detects a first parameter that represents revolution fluctuation of a cylinder of a plurality of cylinders of the engine, with respect to each cylinder; a second parameter calculation portion that calculates, with respect to an unspecified cylinder, a second parameter as a sum of the first parameters of the cylinders other than the unspecified cylinder, and that calculates the second parameter with respect to each cylinder; and an abnormality determination portion that detects an inter-cylinder air/fuel ratio variation abnormality based on the second parameter of each cylinder, and that determines an abnormal cylinder that has the inter-cylinder air/fuel ratio variation abnormality.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a schematic diagram of an internal combustion engine in accordance with an embodiment of the invention;

FIG. 2 is a graph showing output characteristics of a pre-catalyst sensor and a post-catalyst sensor;

FIG. 3 is a time chart for describing the revolution time difference;

FIG. 4 is a time chart for describing the angular velocity difference;

FIG. 5 is a graph showing the angular velocity difference of each cylinder during the normal state and during the abnormal state in a comparative example;

FIG. 6 is a graph showing relations between the angular velocity differences of each cylinder and the engine load during the normal state and during the abnormal state;

FIG. 7 is a graph showing the total angular velocity differences of each cylinder during the normal state and during the abnormal state;

FIG. 8 is a graph showing relations between the total angular velocity difference and the engine load of each cylinder during the normal state and during the abnormal state; and

FIG. 9 is a flowchart showing a routine of an inter-cylinder variation abnormality detection process in the embodiment.

### DETAILED DESCRIPTION OF EMBODIMENTS

Embodiments of the invention will be described hereinafter with reference to the accompanying drawings.

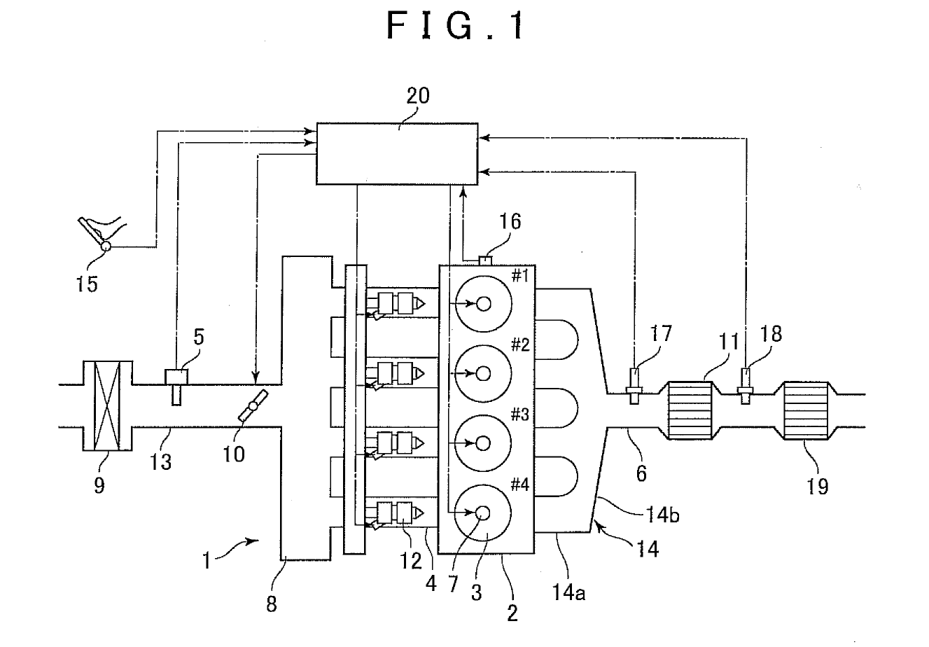

FIG. 1 is a schematic diagram of an internal combustion engine in accordance with an embodiment of the invention. As shown in FIG. 1, an internal combustion engine (engine) 1 produces power by burning a mixture of fuel and air in combustion chambers 3 that are formed in a cylinder block 2 so as to reciprocate a piston in each combustion chamber 3. The engine 1 in accordance this embodiment is a multicylinder internal combustion engine mounted in a motor vehicle and, more concretely, an in-line four-cylinder spark ignition type internal combustion engine. The engine 1 has #1 to #4 cylinders. The number of cylinders of the engine, the type of the engine, the use thereof, etc., are not particularly limited. However, it is preferable that the internal combustion engine 1 have at least three cylinders.

Although not shown, a cylinder head of the internal combustion engine 1 is provided with intake valves that open and close intake ports and exhaust valves that open and close exhaust ports. The intake valves and the exhaust valves are disposed individually for the cylinders, and are opened and closed via camshafts. In a top portion of the cylinder head, ignition plugs 7 for igniting mixture in the combustion chambers 3 are attached separately for each cylinder.

The intake ports of the cylinders are connected to a surge tank 8 that is an intake collective chamber, via branch pipes 4 of the individual cylinders. An intake pipe 13 is connected to an upstream side of the surge tank 8. An upstream end of the intake pipe 13 is provided with an air cleaner 9. An air flow meter 5 for detecting the amount of intake air, and an electronically controlled throttle valve 10 are incorporated in the intake pipe 13 in that order from the upstream side. The intake ports, the branch pipes 4, the surge tank 8 and the intake pipe 13 form an intake passageway.

Injectors (fuel injection valves) 12 that inject fuel into the intake passageway, and particularly, into the intake ports, are provided separately for each cylinder. The fuel injected from each injector 12 is mixed with intake air to form a mixture that is taken into a corresponding one of the combustion chambers 3 when the intake valve is opened. Then, the mixture is compressed by the piston, and is ignited to burn by the ignition plug 7. Incidentally, the injectors may be ones that inject fuel directly into the combustion chambers 3.

On the other hand, the exhaust ports of the cylinders are connected to an exhaust manifold 14. The exhaust manifold 14 is made up of branch pipes 14a that are provided separately for the cylinders and that form an upstream portion of the exhaust manifold 14, and an exhaust collective portion 14b that forms a downstream portion of the exhaust manifold 14. An exhaust pipe 6 is connected to a downstream side of the exhaust collective portion 14b. The exhaust ports, the exhaust manifold 14 and the exhaust pipe 6 form an exhaust passageway.

In an upstream-side portion and a downstream-side portion of the exhaust pipe 6, there are provided an upstream catalyst unit 11 and a downstream catalyst unit 19, respectively, in series. Each of the catalyst units 11 and 19 is made up of a three-way catalyst. These catalyst units 11 and 19 have oxygen storage capability (O₂ storage capability). Specifically, each of the catalyst units 11 and 19 stores excess oxygen present in exhaust gas and therefore reduces NOx when the air/fuel ratio of exhaust gas is greater (leaner) than a stoichiometric ratio (theoretical air/fuel ratio, e.g., A/F=14.6). When the air/fuel ratio of exhaust gas is smaller (richer) than the stoichiometric ratio, each of the catalyst units 11 and 19 releases stored oxygen, resulting in oxidation of HC and CO in exhaust gas.

At the upstream and downstream sides of the upstream catalyst unit 11 there are disposed first and second air/fuel ratio sensors for detecting the air/fuel ratios of exhaust gas at their locations, that is, a pre-catalyst sensor 17 and a post-catalyst sensor 18. The pre-catalyst sensor 17 and the post-catalyst sensor 18 are disposed at positions immediately forward and immediately rearward of the upstream catalyst unit 11, and detect the air/fuel ratio on the basis of the oxygen concentration in exhaust gas. Thus, one pre-catalyst sensor 17 is disposed in an exhaust confluence portion at the upstream side of the upstream catalyst unit 11.

The ignition plugs 7, the throttle valve 10, the injectors 12, etc. that are mentioned above are electrically connected to an electronic control unit (hereinafter, termed the ECU) 20 that is control means. The ECU 20 includes a CPU, a ROM, a RAM, an input/output port, an information storage device, etc. (none of which is shown). Furthermore, as shown in FIG. 1, the ECU 20 is electrically connected to the air flow meter 5, the pre-catalyst sensor 17 and the post-catalyst sensor 18, which are mentioned above, and also to a crank angle sensor 16 that detects the crank angle of the engine 1, an accelerator operation amount sensor 15 that detects the accelerator operation amount, and other various sensors, via A/D converters (not shown) and the like. The ECU 20 controls the ignition plugs 7, the throttle valve 10, the injectors 12, etc., and thereby controls the ignition timing, the fuel injection amount, the fuel injection timing, the throttle opening degree, etc., on the basis of detected values from the various sensors, and the like, so as to achieve a desired output.

The throttle valve 10 is provided with a throttle opening degree sensor (not shown), and a signal from the throttle opening degree sensor is sent to the ECU 20. The ECU 20 usually performs a feedback control of controlling the degree of opening of the throttle valve 10 (throttle opening degree) to a target throttle opening degree that is determined according to the accelerator operation amount.

The ECU 20 detects the intake air amount that is the amount of intake air per unit time, that is, the flow rate of intake air, on the basis of a signal from the air flow meter 5. Then, the ECU 20 detects the load of the engine 1 on the basis of at least one of the detected accelerator operation amount, the detected throttle opening degree and the detected intake air amount.

The ECU 20, on the basis of a crank pulse signal from the crank angle sensor 16, detects the crank angle, and also detects the number of revolutions of the engine 1. Herein, the “number of revolutions” refers to the number of revolutions per unit time, and means the same as the revolution speed. In this embodiment, the number of revolutions refers to the number of revolutions per minute (rpm).

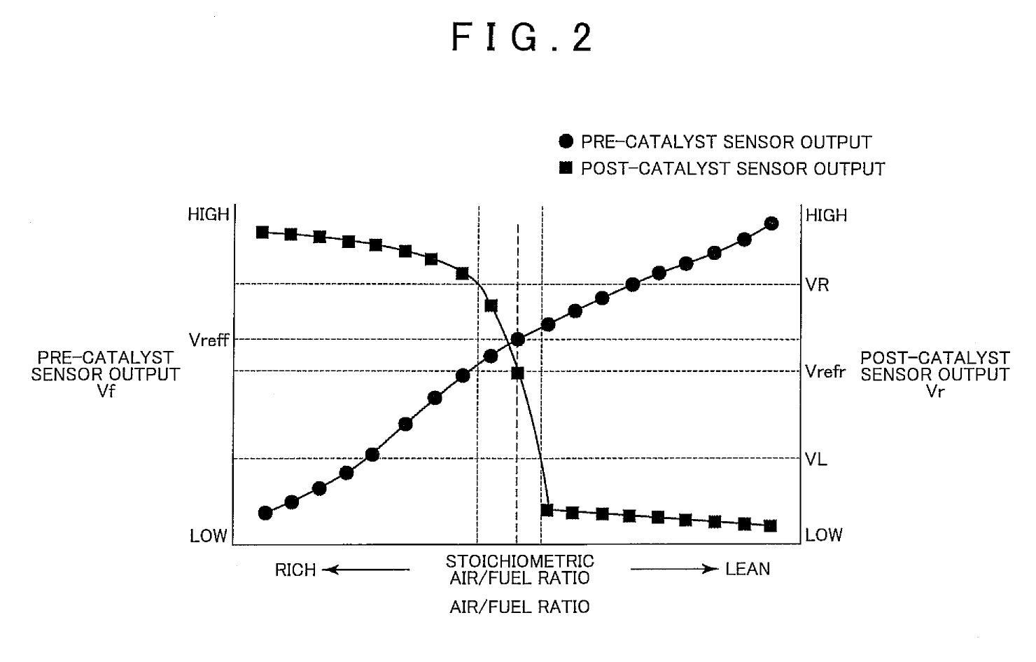

The pre-catalyst sensor 17 is made up of a so-called wide-range air/fuel ratio sensor, and is capable of continuously detecting the air/fuel ratio over a relatively wide range. FIG. 2 shows an output characteristic of the pre-catalyst sensor 17. As shown in FIG. 2, the pre-catalyst sensor 17 outputs a voltage signal Vf whose magnitude is proportional to the exhaust air/fuel ratio. The output voltage that the pre-catalyst sensor 17 produces when the exhaust air/fuel ratio is stoichiometric is Vreff (e.g., about 3.3 V).

On the other hand, the post-catalyst sensor 18 is made up of a so-called O₂ sensor, and has a characteristic in which the output value of the sensor changes sharply in the vicinity of the stoichiometric ratio. FIG. 2 shows the output characteristic of the post-catalyst sensor 18. As shown in FIG. 2, the output voltage that the sensor 18 produces when the exhaust air/fuel ratio is stoichiometric, that is, a stoichiometric ratio-corresponding voltage value, is Vrefr (e.g., 0.45 V). The output voltage of the post-catalyst sensor 18 changes within a predetermined range (e.g., of 0 to 1 V). When the exhaust air/fuel ratio is leaner than the stoichiometric ratio, the output voltage of the post-catalyst sensor is lower than the stoichiometric ratio-corresponding voltage value Vrefr, and when the exhaust air/fuel ratio is richer than the stoichiometric ratio, the output voltage of the post-catalyst sensor is higher than the stoichiometric ratio-corresponding value Vrefr.

Each of the upstream catalyst unit 11 and the downstream catalyst unit 19 is capable of simultaneously removing NOx, HC and CO, which are pollutants in exhaust gas, when the air/fuel ratio A/F of the exhaust gas that flows into the catalyst unit is in the vicinity of the stoichiometric ratio. The width (window) of the air/fuel ratio in which the three pollutants can be simultaneously removed with high efficiency is relatively narrow.

Therefore, during usual operation, the ECU 20 executes an air/fuel ratio feedback control of controlling the air/fuel ratio in the combustion chambers, concretely, the fuel injection amount, in such a manner that the air/fuel ratio of the exhaust gas that flows into the upstream catalyst unit 11 is controlled to the vicinity of the stoichiometric ratio. The air/fuel ratio feedback control includes a main air/fuel ratio feedback control in which the exhaust air/fuel ratio detected by the pre-catalyst sensor 17 is caused to be equal to the stoichiometric ratio, which is a predetermined target air/fuel ratio, and a subsidiary air/fuel ratio feedback control in which the exhaust air/fuel ratio detected by the post-catalyst sensor 18 is caused to be equal to the stoichiometric ratio.

Incidentally, the air/fuel ratio feedback control whose target air/fuel ratio is the stoichiometric ratio is termed the stoichiometric control. The stoichiometric ratio is a reference air/fuel ratio, and the amount of fuel injection that corresponds to the stoichiometric ratio is a reference amount of the fuel injection amount.

For example, it sometimes happens that at least one of the cylinders (in particular, one cylinder) has failure of the injector 12 or the like and therefore variation in the air/fuel ratio (imbalance) among the cylinders occurs. An example of such a case is a case where the fuel injection amount of, for example, the #1 cylinder, becomes relatively large due to failure of the injector 12 of the #1 cylinder and therefore the air/fuel ratio of the #1 cylinder deviates greatly to the rich side. Even in this case, the air/fuel ratio of a total gas supplied to the pre-catalyst sensor 17 can sometimes be controlled to the stoichiometric ratio if a relatively large correction amount is given by the aforementioned stoichiometric control. However, this is a state in which, in view of the individual cylinders, the air/fuel ratio of the #1 cylinder is greatly richer than the stoichiometric ratio, and the air/fuel ratio of each of the #2, #3 and #4 cylinders is slightly leaner than the stoichiometric ratio, and the stoichiometric ratio is obtained merely as an overall balance. Thus, this state is apparently not good in terms of emission quality. Therefore, in this embodiment there is provided a device that detects such an inter-cylinder air/fuel ratio variation abnormality.

It is to be noted herein that a value termed the imbalance rate (%) is used as an index that represents the degree of variation in air/fuel ratio among the cylinders. That is, the imbalance rate shows, if only a certain one of the cylinders has a deviation in the fuel injection amount, by what percentage the fuel injection amount of the cylinder having a fuel injection amount deviation (imbalance cylinder) is deviated from the fuel injection amount of each of the cylinders that do not have any fuel injection amount deviation (balance cylinders). The imbalance rate IB is expressed by IB=(Qib−Qs)/Qs×100 where Qib is the fuel injection amount of the imbalance cylinder and Qs is the fuel injection amount of the balance cylinders. As the imbalance rate IB (%) is greater, the fuel injection amount deviation of the imbalance cylinder relative to the balance cylinders is greater and the degree of variation in air/fuel ratio is greater.

On the other hand, the embodiment uses a first parameter that represents fluctuation in revolution of each cylinder when detecting the inter-cylinder air/fuel ratio variation abnormality. The fluctuation in revolution (revolution fluctuation) refers to change in the engine revolution speed or in the crankshaft revolution speed. In the following description, the imbalance rate is used only for the purpose of description. The first parameter is detected with respect to each cylinder, separately for the individual cylinders.

Hereinafter, a preferred example of the first parameter will be described. Incidentally, the first parameter may be other than those described below, that is, may be, for example, a parameter known to public.

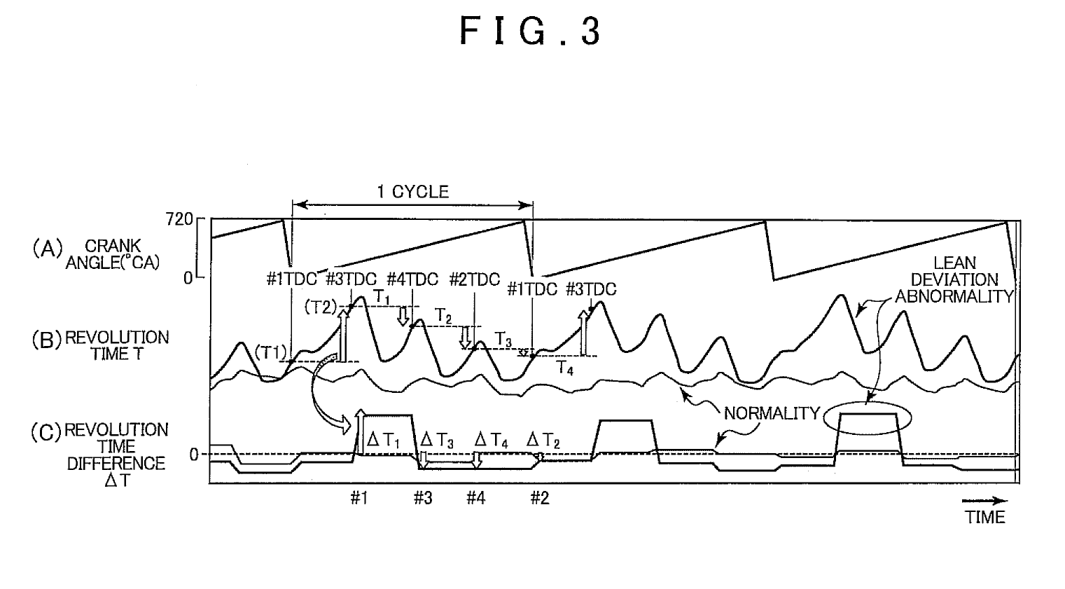

Firstly, reference will be made to FIG. 3. In FIG. 3, graph (A) shows the crank angle (° CA). One engine cycle is 720 (° CA). In FIG. 3, the crank angle, which is herein successively detected, is shown for a plurality of cycles in a sawtooth form.

Graph (B) in FIG. 3 shows the time that it takes for the crankshaft to turn a predetermined angle, that is, the revolution time T (s/° CA). The predetermined angle herein is 30 (° CA), but may also be a different value (e.g., 10, 20, 120, 180 (° CA), etc.). As the revolution time T is longer, the engine revolution speed is less. Conversely, as the revolution time T is shorter, the engine revolution speed is greater. The revolution time T is detected by the ECU 20 on the basis of the output of the crank angle sensor 16. Incidentally, as is apparent from the drawings, the firing order of the cylinder is the order of #1, #3, #4 and #2.

Graph (C) shows revolution time difference ΔT described below. In FIG. 3, “NORMALITY” indicates a normal case where none of the cylinders has air/fuel ratio deviation, and “LEAN DEVIATION ABNORMALITY” shows an abnormal case where only the #1 cylinder has a lean deviation of, for example, an imbalance rate IB=−30(%). The lean deviation abnormality occurs due to, for example, the clogging of the injection hole of an injector or improper valve opening thereof.

Firstly, the revolution time T of each cylinder at the same timing is detected by the ECU. In this example, the revolution time T at the timing of the compression top dead center (TDC) of each cylinder is detected. The timing at which the revolution time T is detected is termed the detection timing.

At every detection timing, the ECU calculates a difference (T2−T1) between the revolution time T2 at the present detection timing and the revolution time T1 at the immediately previous detection timing. This difference is the revolution time difference ΔT shown by graph (C) in FIG. 3, that is, ΔT=T2−T1.

Usually, during the combustion stroke of a cylinder after the crank angle exceeds the TDC, the revolution speed rises and therefore the revolution time T decreases, and during the compression stroke of the next injection cylinder, the revolution speed decreases and therefore the revolution time T increases.

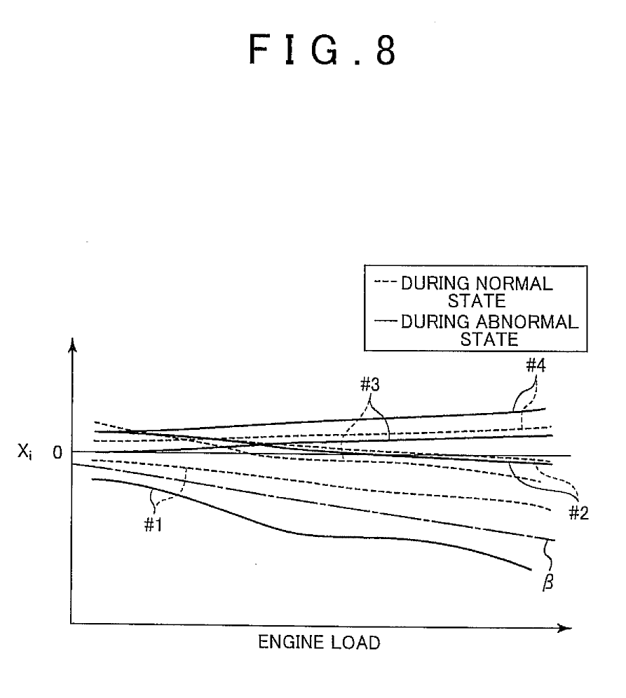

However, as shown in graph (B) of FIG. 3, if the #1 cylinder has a lean deviation abnormality, ignition in the #1 cylinder will not bring about sufficient torque and therefore the revolution speed does not easily rise, so that the revolution time T at the #3 cylinder's TDC is great. Hence, the revolution time difference ΔT at the #3 cylinder's TDC is a great positive value as shown in graph (C) of FIG. 8. The revolution time and the revolution time difference at the #3 cylinder's TDC are defined as the revolution time and the revolution time difference of the #1 cylinder, and are represented by T₁ and ΔT₁, respectively. This similarly applies to the other cylinders as well.

Next, when the #3 cylinder is fired, the revolution speed sharply rises since the #3 cylinder is normal. This results in only a slight decrease in the revolution time T at the timing of the #4 cylinder's TDC in comparison with the revolution time T detected at the #3 cylinder's TDC. Therefore, the revolution time difference ΔT₃ of the #3 cylinder detected at the #4 cylinder's TDC is a small negative value as shown in graph (C) of FIG. 3. Thus, the revolution time difference ΔT of a cylinder is detected at every TDC of the next firing cylinder.

After that, a tendency similar to that observed at the #4 cylinder's TDC is observed at the #2 cylinder's TDC and the #1 cylinder's TDC as well, and the revolution time difference ΔT₄ of the #4 cylinder and the revolution time difference ΔT₂ of the #2 cylinder detected at the two TDC timings are both small negative values. The above-described characteristic is repeated every engine cycle.

On the other hand, during the normal state, the revolution time difference ΔT of each cylinder is always in the vicinity of zero as shown in graph (C) of FIG. 3.

Thus, it can be understood that the revolution time difference ΔTi (i=1, 2, 3, 4) is a value that represents fluctuation in revolution of each cylinder, and a value that correlates with the amount of deviation of the air/fuel ratio of each cylinder. That is, as the amount of deviation of the air/fuel ratio of each cylinder is greater, the fluctuation of revolution of each cylinder is greater and the revolution time difference ΔTi of each cylinder is greater. Hence, the revolution time difference ΔTi of each cylinder can be used as the first parameter that represents fluctuation of revolution of each cylinder.

However, in this embodiment, as an alternative, a value indicated below that is similar to the revolution time difference ΔTi of each cylinder is used as the first parameter. The revolution time difference ΔTi of each cylinder may naturally be used as a first parameter.

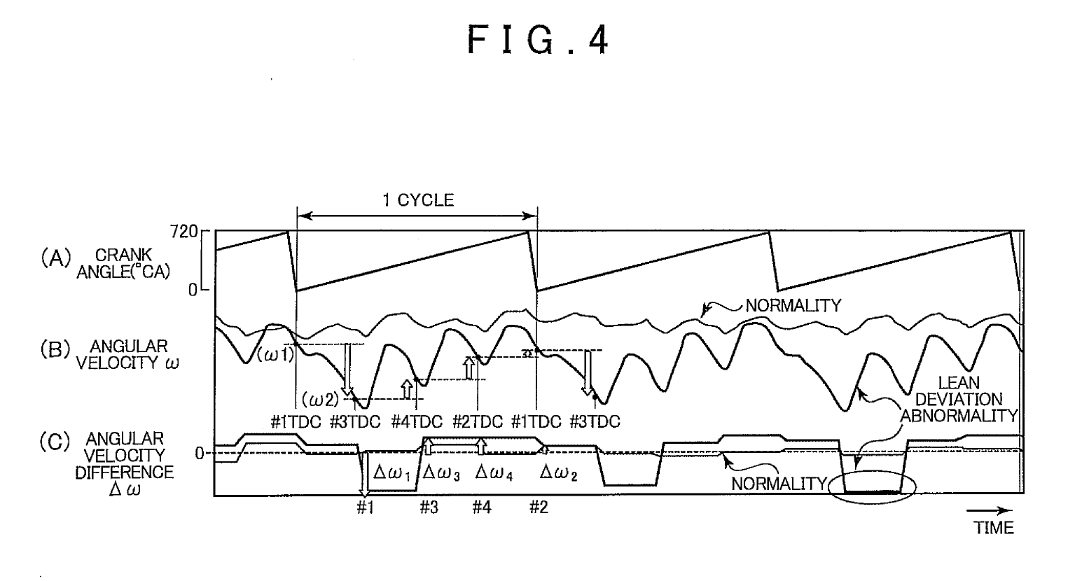

Refer to FIG. 4. In FIG. 4, graph (A), similar to graph (A) of FIG. 3, shows the crank angle (° CA) of the engine.

Graph (B) of FIG. 4 shows the angular velocity ω (° CA/s), which is a reciprocal of the revolution time T. That is, ω=1/T. Naturally, as the angular velocity ω is larger, the engine revolution speed is greater, and as the angular velocity ω is smaller, the engine revolution speed is less. The waveform of the angular velocity ω is a form obtained by inverting the waveform of the revolution time T upside down.

Graph (C) of FIG. 4 shows the angular velocity difference Δω that is a difference in the angular velocity ω, similar to the revolution time difference ΔT. The waveform of the angular velocity difference Δω is also a form obtained by inverting the waveform of the revolution time difference ΔT upside down. The terms “NORMALITY” and “LEAN DEVIATION ABNORMALITY” in FIG. 4 mean the same as those in FIG. 3.

Firstly, the angular velocity ω of each cylinder at the same timing is detected by the ECU. In this example, too, the angular velocity ω at the timing of the compression top dead center (TDC) of each cylinder is detected. The angular velocity ω is calculated by dividing “1” by the revolution time T.

Next, at every detection timing, a difference (ω2−ω1) between the angular velocity ω2 at the present detection timing and the angular velocity ω1 at the immediately previous detection timing is calculated by the ECU. This difference is the angular velocity difference Δω shown by graph (C) of FIG. 4, that is, Δω=ω2−ω1.

Usually, during the combustion stroke of a cylinder after the crank angle exceeds the TDC, the revolution speed rises and therefore the angular velocity ω rises, and then during the compression stroke of the next firing cylinder, the revolution speed decreases and therefore the angular velocity ω decreases.

However, as shown in graph (B) in FIG. 4, if the #1 cylinder has a lean deviation abnormality, ignition in the #1 cylinder will not bring about sufficient torque and therefore the revolution speed does not easily rise, so that, as an effect of this, the angular velocity ω at the #3 cylinder's TDC is small. Hence, the angular velocity difference Δω at the #3 cylinder's TDC is a great negative value as shown in graph (C) in FIG. 4. The angular velocity and the angular velocity difference at the #3 cylinder's TDC are defined as the angular velocity and the angular velocity difference of the #1 cylinder, and are represented by ω₁ and Δω₁, respectively. This similarly applies to the other cylinders as well.

As for the relation between the angular velocity ω1 at the #1 cylinder's TDC and the angular velocity ω2 at the #3 cylinder's TDC, ω1>ω2, that is, the #1 cylinder has a speed reduction-side revolution fluctuation.

Next, when the #3 cylinder is fired, the revolution speed sharply rises since the #3 cylinder is normal. This results in only a slight increase in the angular velocity ω at the time of the #4 cylinder's TDC in comparison with the angular velocity ω at the #3 cylinder's TDC. Therefore, the revolution time difference Δω₃ of the #3 cylinder detected at the #4 cylinder's TDC is a small positive value as shown in graph (C) in FIG. 4. Thus, the angular velocity difference Δω of a cylinder is detected at every TDC of the next firing cylinder. In this case, as for the relation between the angular velocity ω1 at the #3 cylinder's TDC and the angular velocity ω2 at the #4 cylinder's TDC, ω1<ω2, that is, the #3 cylinder has a speed increase-side revolution fluctuation.

After that, a tendency similar to that observed at the #4 cylinder's TDC is observed at the #2 cylinder's TDC and the #1 cylinder's TDC as well, and the angular velocity difference Δω₄ of the #4 cylinder and the angular velocity difference Δω₂ of the #2 cylinder detected at the two TDC timings are both small positive values. The above-described characteristic is repeated every engine cycle.

On the other hand, during the normal state, the angular velocity difference Δω of each cylinder is always in the vicinity of zero as shown in graph (C) in FIG. 4.

Thus, it can be understood that the angular velocity difference Δωᵢ (i=1, 2, 3, 4) of each cylinder is a value that represents the revolution fluctuation of each cylinder, and that correlates with the amount of deviation in the air/fuel ratio of each cylinder. As the air/fuel ratio deviation amount of each cylinder is greater, the revolution fluctuation thereof is greater and the angular velocity difference Δωᵢ thereof is smaller (greater in the negative direction).

Therefore, in this embodiment, the angular velocity difference Δωᵢ of each cylinder is used as a first parameter that represents the revolution fluctuation of each cylinder.

Incidentally, a conceivable comparative example to this embodiment is an apparatus that detects the inter-cylinder air/fuel ratio variation abnormality on the basis of the angular velocity difference Δωᵢ of each cylinder. In this apparatus, if the angular velocity difference Δωᵢ of each cylinder is individually compared with a predetermined abnormality determination value α (<0) and it is found that there exists an angular velocity difference Δωᵢ that is smaller than the abnormality determination value α, the inter-cylinder air/fuel ratio variation abnormality is detected, and the cylinder that corresponds to the angular velocity difference Δωᵢ is specifically determined as being an abnormal cylinder that has the inter-cylinder air/fuel ratio variation abnormality. That is, in such a case, it is detected that the cylinder that corresponds to the angular velocity difference Δωᵢ has the air/fuel ratio deviation abnormality. Incidentally, the state in which the angular velocity difference Δω is smaller than the abnormality determination value a means the same as the state in which the revolution fluctuation that corresponds to the angular velocity difference Δω is greater to the speed reduction side than the revolution fluctuation that corresponds to the abnormality determination value a or the state in which the revolution fluctuation that corresponds to the angular velocity difference Δω is greater in fluctuation and slower in revolution than the revolution fluctuation that corresponds to the abnormality determination value α.

This comparative example, as shown in FIG. 4, is suitable for detection of the lean deviation abnormality in which the air/fuel ratio of a cylinder deviates to the lean side. This is because if the air/fuel ratio of a cylinder deviates greatly to the lean side, the amount of fuel in that cylinder becomes insufficient, the produced torque decreases and the revolution speed or revolution fluctuation changes to the speed reduction side.

However, on the other hand, if there occurs a rich deviation abnormality in which the air/fuel ratio of a cylinder deviates to the rich side, it is sometimes difficult to detect the inter-cylinder air/fuel ratio variation abnormality according to the comparative example. If the air/fuel ratio of a cylinder deviates greatly to the rich side, the cylinder merely has an excess amount of fuel, so that the produced torque rather increases and the revolution speed or revolution fluctuation does not change much or changes rather to the speed increase side. In this case, the angular velocity difference Δωᵢ of the cylinder with the rich deviation abnormality is in the vicinity of zero as in the time of normality, or becomes large in the positive direction. Hence, the angular velocity difference Δωᵢ does not become smaller than the abnormality determination value α of the minus sign, so that the great deviation of the air/fuel ratio of that cylinder to the rich side cannot be detected as the inter-cylinder air/fuel ratio variation abnormality.

However, in the case where the air/fuel ratio of a cylinder deviates to the rich side so greatly as to exceed the rich limit, the amount of fuel is excessive large, so that ignition of fuel result in insufficient combustion. In that case, therefore, as in the case where the lean deviation abnormality has occurred, the produced torque reduces, and the revolution speed or revolution fluctuation changes to the speed reduction side and an angular velocity difference Δωᵢ that is smaller than the abnormality determination value α is obtained, so that the inter-cylinder variation abnormality can be detected. Thus, the advantageous effect of the comparative example at the time of occurrence of the rich deviation abnormality is very much limited.

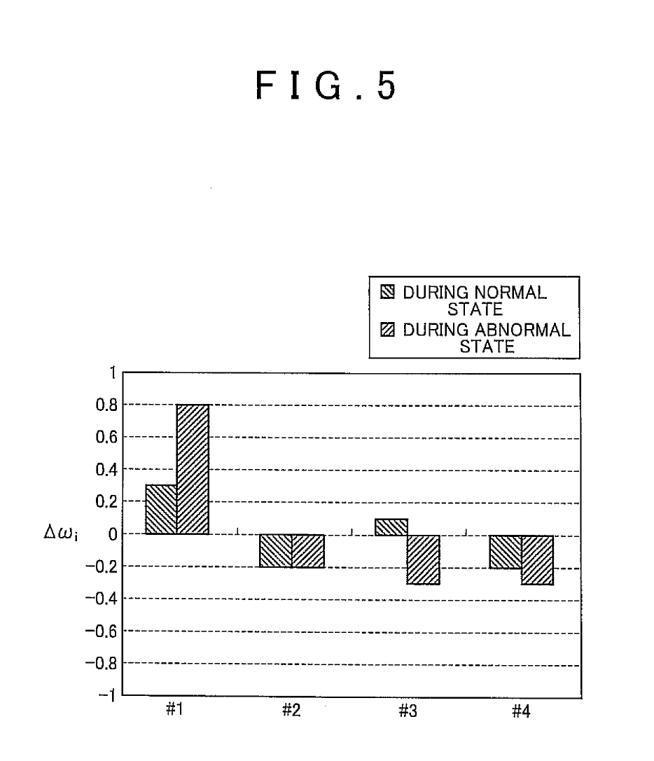

FIG. 5 shows the angular velocity difference Δωᵢ of each cylinder during the normal state and during the abnormal state in the comparative example. This diagram shows values that occur during execution of the above-described air/fuel ratio feedback control, concretely, the stoichiometric control. The normal state refers to a case where none of the cylinders has air/fuel ratio deviation and the amounts of fuel injection of all the cylinders are a stoichiometric ratio-corresponding amount Qs. The abnormal state refers to a case where only the #1 cylinder has a rich deviation abnormality in which the imbalance rate IB=+50(%). Incidentally, the numerical values indicated herein are merely illustrative.

As shown in FIG. 5, during the normal state, the amount of fuel injection of each cylinder is the stoichiometric ratio-corresponding amount Qs, and the angular velocity differences Δωᵢ of all the cylinders are close to zero. However, it can be observed that the angular velocity difference Δωᵢ slightly varies among the cylinders, that is, Δω₁=0.3, Δω₂=0.2, Δω₃=0.1 and Δω₄=0.2.

If from this state, only the #1 cylinder comes to have a rich deviation abnormality with the imbalance rate IB=+50(%), the amount of fuel injection of the #1 cylinder alone changes to 1.5 times the stoichiometric ratio-corresponding amount Qs, that is, 1.5Qs. However, as a result of the stoichiometric control subsequently performed, the amounts of fuel injection of all the cylinders are uniformly reduced by an amount that corresponds to IB=12.5(%), that is, 0.125Qs, more specifically, the amount of fuel injection of the #1 cylinder changes to 1.375Qs and the amounts of fuel injection of the #2 to #4 cylinders change to 0.875Qs. The angular velocity difference Δωᵢ of each cylinder occurring when the amount of fuel injection of each cylinder has finished changing as a result of the stoichiometric control a certain amount of time following occurrence of the rich deviation abnormality is the angular velocity difference Δωᵢ of each cylinder during the abnormal state shown in FIG. 5.

As shown in FIG. 5, during the abnormal state, the amount of fuel injection of the #1 cylinder increases to 1.375Qs, which is conspicuously greater than the stoichiometric ratio-corresponding amount Qs, so that the air/fuel ratio becomes conspicuously richer than the stoichiometric ratio. Therefore, the produced torque increases, and the angular velocity difference Δω₁ of the #1 cylinder conspicuously increases to 0.8 on the speed increase side. On the other hand, with regard to the other cylinders that are normal, that is, the #2 to #4 cylinders, the amount of fuel injection decreases to 0.875Qs, which is slightly less than the stoichiometric ratio-corresponding amount Qs. Therefore, the produced torque decreases, and the angular velocity difference Δωᵢ of each of the three cylinders exhibits a tendency of slight decrease. While the angular velocity difference Δω₂ of the #2 cylinder remains unchanged at −0.2, the angular velocity differences Δω₃ and Δω₄ of the #3 cylinder and the #4 cylinder both decrease to −0.3 on the speed reduction side.

However, as for the #2 to #4 cylinders, whose angular velocity differences Δωᵢ have a minus tendency, the absolute values of the angular velocity differences Δωᵢ do not become very large. Furthermore, the amounts of change or the differences of the angular velocity differences Δωᵢ occurring in the negative direction (to the speed reduction side) at the time of change from the normal state to the abnormal state are not very large. Hence, it is difficult to set an abnormality determination value that separates the normal state and the abnormal state from each other, and it is hard to discriminate the two states. Since the difference in the angular velocity difference Δωᵢ between the normal state and the abnormal state, that is, the margin in determination, is small, it is difficult to separate the two states from each other.

Incidentally, with regard to the #1 cylinder, the angular velocity difference Δω₁ changes comparatively greatly (by 0.5) in the positive direction at the time of change from the normal state to the abnormal state in the example shown in FIG. 5. Hence, it is conceivable to utilize this change in order to detect the rich deviation abnormality of the #1 cylinder. In reality, however, the angular velocity difference Δωᵢ during the normal state sometimes becomes a comparatively large positive value according to the state of operation of the engine (e.g., at the time of acceleration). Hence, it is not only during the abnormal time that the angular velocity difference Δωᵢ changes greatly in the positive direction. Therefore, utilization of the aforementioned characteristic is difficult.

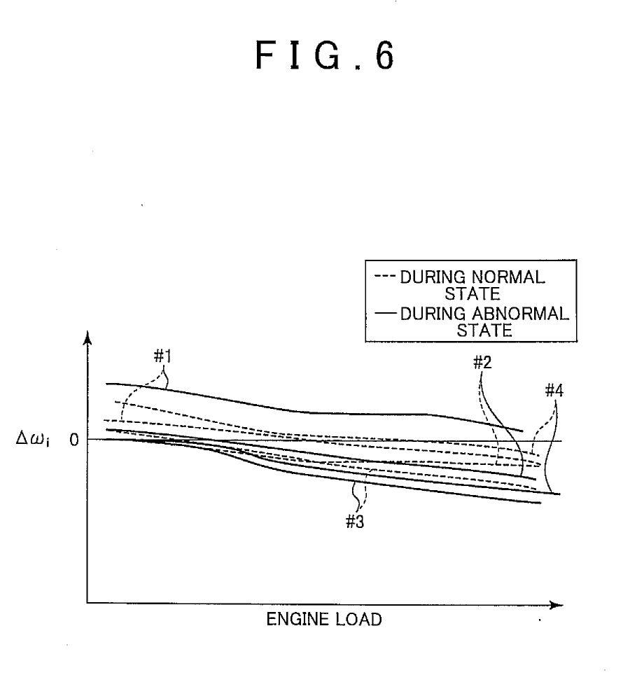

FIG. 6 shows relations between the angular velocity differences Δωᵢ of each cylinder and the engine load during the normal state and during the abnormal state. Incidentally, the definitions of the normal state and the abnormal state are the same as those adopted in the example shown in FIG. 5. Furthermore, for example, “#1” indicates the angular velocity differences Δω₁ of #1 cylinder.

As shown in FIG. 6, the data of the angular velocity difference Δωᵢ of each cylinder during the abnormal state are contained within the range of the angular velocity difference Δωᵢ of each cylinder during the normal state. In this situation, it is hard to set an abnormality determination value, and it is hard to detect the inter-cylinder variation abnormality. It is, of course, hard to specifically determine an abnormal cylinder, and therefore it may become necessary to develop a new logic for specifically determining an abnormal cylinder.

Using the angular velocity difference Δωᵢ of each cylinder, which is the first parameter, it is possible to suitably detect the air/fuel ratio rich deviation abnormality of a cylinder or the inter-cylinder air/fuel ratio variation abnormality based on the air/fuel ratio rich deviation abnormality of a cylinder.

In this embodiment, a second parameter for an unspecified cylinder is calculated as the sum of the first parameters of all the cylinders other than the unspecified cylinder. Concretely, for example, the second parameter of the #1 cylinder is calculated as the sum of the angular velocity difference Δω₂ of the #2 cylinder, the angular velocity difference Δω₃ of the #3 cylinder and the angular velocity difference Δω₄ of the #4 cylinder. The second parameter calculated in the foregoing manner will be termed the total angular velocity difference, and is represented by Xᵢ. For example, X₁=Δω₂+Δω₃+Δω₄

Likewise, the total angular velocity difference X₂ of the #2 cylinder is X₂=Δω₁+Δω₃+Δω₄, the total angular velocity difference X₃ of the #3 cylinder is X₃=Δω₁+Δω₂+Δω₄, and the total angular velocity difference X₄ of the #4 cylinder is X₄=Δω₁+Δω₂+Δω₃. In this manner, the second parameter is calculated with respect to each cylinder.

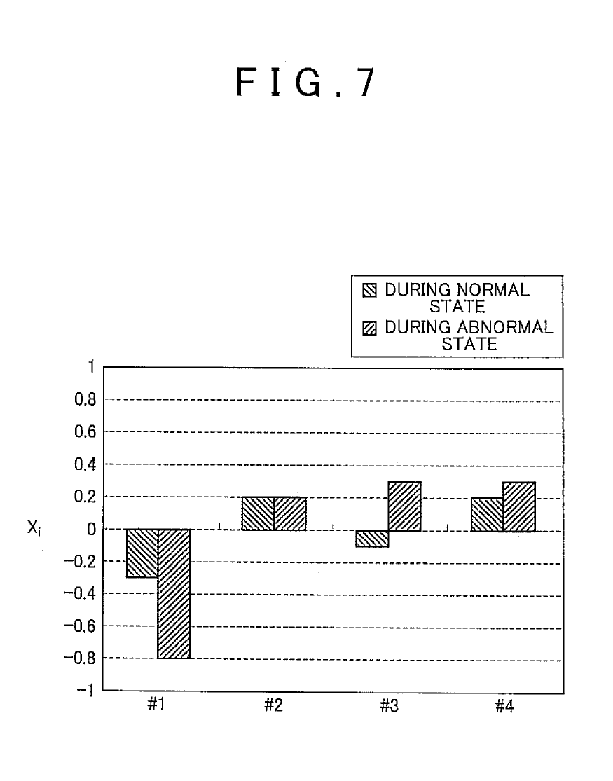

Results of the calculation of the total angular velocity difference Xᵢ of each cylinder through the use of the example shown in FIG. 5 are as shown in FIG. 7.

As shown in FIG. 7, during the normal state, all the total angular velocity differences Xᵢ of the cylinders are substantially in the vicinity of zero, that is, X₁=−0.3, X₂=0.2, X₃=−0.1 and X₄=−0.2.

On the other hand, during the abnormal state, the total angular velocity differences Xᵢ of the cylinders are X₁=−0.8, X₂=0.2, X₃=0.3 and X₄=0.3. In particular, with regard to the #1 cylinder, which is an abnormal cylinder, the total angular velocity difference X₁ changes greatly in the negative direction (to the speed reduction side) from −0.3 during the normal state to −0.8 during the abnormal state. On the other hand, with regard to the normal cylinders #2 to #4, no such great change in the negative direction is exhibited. With regard to a normal cylinder, the large positive angular velocity difference Δω₂ of the #1 cylinder and the small negative angular velocity differences Δω of the other normal cylinders offset each other to make a small positive total angular velocity difference X as a whole.

Hence, utilizing this characteristic, it is possible to suitably detect the air/fuel ratio rich deviation abnormality of a cylinder or the inter-cylinder air/fuel ratio variation abnormality based on the air/fuel ratio rich deviation abnormality of a cylinder.

The amount of change in the negative direction of the total angular velocity difference Xᵢ of an abnormal cylinder at the time of change from the normal state to the abnormal state is large. Hence, it is easy to set an abnormality determination value that separates the normal state and the abnormal state from each other. Since the difference in the total angular velocity difference Xᵢ between the normal state and the abnormal state, that is, the determination margin, is large, it is easy to separate the two states from each other. In the example shown in FIG. 7, the abnormality determination value may be set to, for example, −0.6, and the normal state and the abnormal state can be certainly separated from each other by using the aforementioned abnormality determination value.

Such a large change in the negative direction occurs only with regard to the abnormal cylinder. Hence, it is also easy to specifically determine an abnormal cylinder.

As a result, in this embodiment, similarly to the comparative example, the total angular velocity differences Xᵢ of the cylinders are individually compared with a predetermined abnormality determination value β (<0), and if there exists a total angular velocity difference Xᵢ that is smaller than the abnormality determination value β, the inter-cylinder air/fuel ratio variation abnormality based on the rich deviation abnormality is detected and the cylinder that corresponds to the total angular velocity difference Xᵢ is specifically determined as an abnormal cylinder. In other words, in such a case, it is detected that the rich deviation abnormality has occurred on the cylinder that corresponds to that total angular velocity difference Xᵢ. Incidentally, the state in which the total angular velocity difference X is smaller than the abnormality determination value β means the same as the state in which the revolution fluctuation that corresponds to the total angular velocity difference X is greater to the speed reduction side than the revolution fluctuation that corresponds to the abnormality determination value β or the state in which the revolution fluctuation that corresponds to the total angular velocity difference X is greater in fluctuation and slower in revolution than the revolution fluctuation that corresponds to the abnormality determination value β.

In the embodiment, the second parameter (total angular velocity difference Xᵢ) of, for example, the #1 cylinder, is handled as the sum (Δω₂+Δω₃+Δω₄) of the angular velocity differences of the cylinders other than the #1 cylinder, that is, the #2, #3 and #4 cylinders. In this manner, the air/fuel ratio of each of the cylinders other than the #1 cylinder becomes slightly leaner than the stoichiometric ratio through the stoichiometric control following the occurrence of the rich deviation abnormality of the #1 cylinder, and the angular velocity differences of the cylinders other than the #1 cylinder which have changed little by little to the speed reduction side of zero can be collectively reflected in the second parameter of the #1 cylinder. Therefore, as a result, the total angular velocity difference Xᵢ of the #1 cylinder can be caused to change greatly to the speed reduction side of zero, and the difference in the total angular velocity difference Xᵢ between the normal state and the abnormal state can be enlarged.

FIG. 8, similar to FIG. 6, shows relations between the total angular velocity difference Xᵢ of each cylinder and the engine load during the normal state and during the abnormal state. As shown in FIG. 8, only the total angular velocity difference Xᵢ of the #1 cylinder (abnormal cylinder) during the abnormal state is greatly deviated in the negative direction (to the speed reduction side) from other data or other groups of data. Hence, by setting abnormality determination value β between the total angular velocity difference X₁ of the #1 cylinder during the abnormal state and the total angular velocity difference X₁ of the #1 cylinder during the normal state as shown in FIG. 8, it is possible to easily and accurately perform the detection of the inter-cylinder variation abnormality detection and the specific determination of an abnormal cylinder.

In particular, the total angular velocity difference X₁ of the #1 cylinder during the abnormal state tends to increase in the negative direction as the engine load increases. Hence, it is preferable that, in accordance with this tendency, the abnormality determination value β be set according to the engine load. More concretely, it is preferable that the abnormality determination value β be set to a larger value in the negative direction as the engine load is larger. In this embodiment, the relation between the abnormality determination value β and the engine load as shown in FIG. 8 is stored beforehand in the form of a map (which may also be replaced by a function) in the ECU 20.

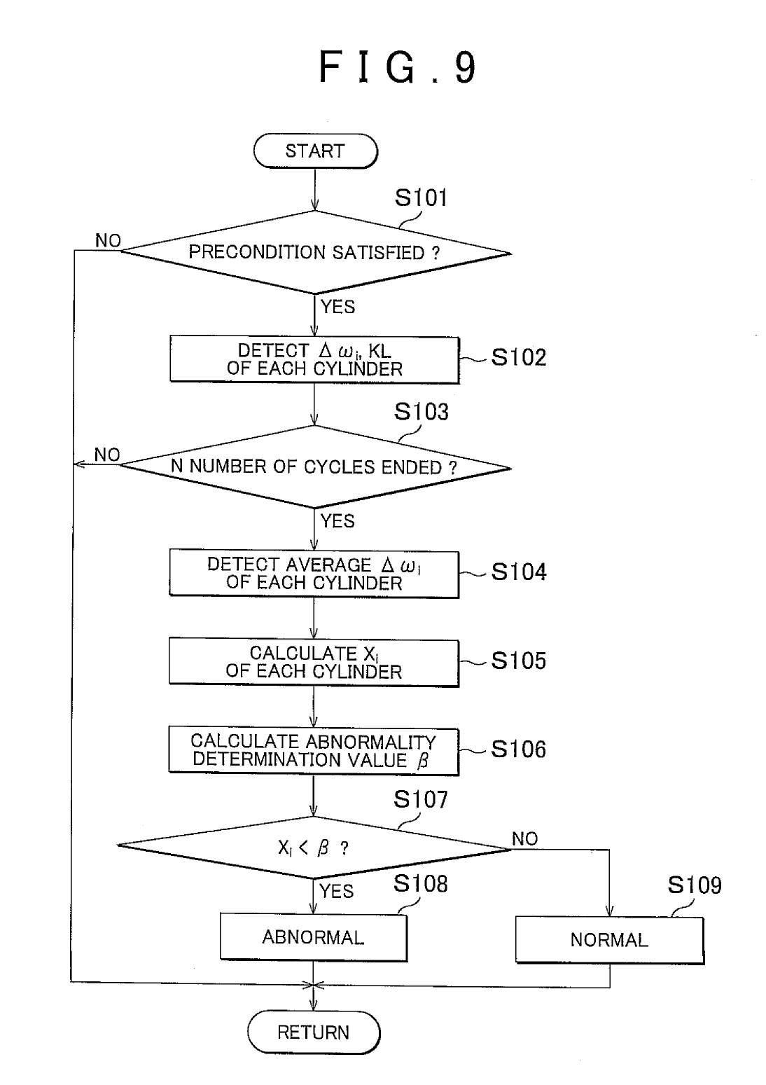

Next, an inter-cylinder variation abnormality detection process in the embodiment will be described. FIG. 9 shows a routine of the inter-cylinder variation abnormality detection process. This routine is repeatedly executed by the ECU 20 at every predetermined calculation period.

In step S101, it is determined whether a predetermined precondition suitable for the abnormality detection has been satisfied. The precondition is satisfied, for example, when (1) the engine is in the warmed-up state, (2) the upstream catalyst 11 and the downstream catalyst unit 19 are in the warmed-up state, (3) the pre-catalyst sensor 17 and the post-catalyst sensor 18 are in the activated state, (4) the engine is in a steady operation state, and (5) the stoichiometric control is being executed.

Whether the condition (1) has been satisfied is determined on the basis of a detected value from the water temperature sensor (not shown); for example, the condition (1) is satisfied when the detected value from the water temperature sensor is 75° C. or higher. Whether the condition (2) has been satisfied is determined on the basis of the temperature of each catalyst unit that is detected or estimated. Whether the condition (3) has been satisfied is determined on the basis of the detected value of the element temperature based on the element impedance of each of the sensors. Whether the condition (4) has been satisfied is determined on the basis of, for example, whether the widths of fluctuation of the intake air amount Ga and the engine revolution speed Ne in a predetermined period are within predetermined ranges. Incidentally, the precondition is not limited to the aforementioned precondition, but may also be a precondition other than the aforementioned precondition.

If the precondition has not been satisfied, the present execution of the process is ended. If the precondition has been satisfied, the process proceeds to step S102.

In step S102, the angular velocity difference Δωᵢ of each cylinder and the engine load KL are detected.

Subsequently, in step S103, it is determined whether N number of engine cycles following the start of detection in step S102 have ended. N is an integer of 2 or greater which is determined beforehand, for example, 100. If N number of engine cycles have not ended, the process is ended. If N number of engine cycles have ended, the process proceeds to step S104.

In step S104, an average angular velocity difference Δωavᵢ of each cylinder is calculated. Concretely, an average value of the angular velocity difference Δωᵢ of each cylinder is found by dividing the sum of detected values of the angular velocity difference Δωᵢ of the cylinder by the number N of samples, and the found average value of each cylinder is determined as the average angular velocity difference Δωavᵢ thereof.

In step S105, the total angular velocity difference Xᵢ of each cylinder is calculated. As can be understood from the foregoing description, the total angular velocity difference Xᵢ of, for example, the #1 cylinder, is expressed as in X₁=Δωav₂+Δωav₃+Δωav₄.

Subsequently, in step S106, the abnormality determination value β commensurate with the engine load KL is calculated. Concretely, the average load is found by dividing the sum of detected values of the engine load KL by the number 4N of samples (the number of cylinders×the number of engine cycles), and an abnormality determination value β that corresponds to the found average load is calculated from a map as shown in FIG. 8. The abnormality determination value β is a negative value.

Then, in step S107, the total angular velocity difference Xᵢ of each cylinder is compared with the abnormality determination value β.

If the total angular velocity difference Xᵢ of any one of the cylinders is smaller than the abnormality determination value β, that is, if there exists a total angular velocity difference Xᵢ that is smaller than the abnormality determination value β, the process proceeds to step S108, in which it is determined that the inter-cylinder variation abnormality is present. Then, the cylinder that corresponds to the total angular velocity difference Xᵢ that is smaller than the abnormality determination value β is specifically determined as an abnormal cylinder that has the inter-cylinder air/fuel ratio variation abnormality.

On the other hand, if the total angular velocity difference Xᵢ of any one of the cylinders is greater than or equal to the abnormality determination value β, that is, if there does not exist a total angular velocity difference Xᵢ that is smaller than the abnormality determination value β, the process proceeds to step S109, in which it is determined that the inter-cylinder variation abnormality is not present, that is, the current state is normal.

While the preferred embodiments of the invention have been described in detail above, various other embodiments of the invention can also be conceived. For example, the aforementioned numerical values are illustrative, and various modifications thereof are possible. In the foregoing embodiments, the crank angle sensor 16 functions as a first parameter detection portion, and the ECU 20 functions as a second parameter calculation portion and an abnormality determination portion.

Furthermore, the invention is also applicable to engines other than the in-line four-cylinder engines. For example, in the case where, in a V-type multicylinder (six-cylinder, eight-cylinder, etc.) engine, each bank has a plurality of cylinders, it is possible to apply the constructions, the controls, the inter-cylinder variation abnormality detection process, etc., that are substantially the same as those described above in conjunction with the embodiments to the group of cylinders of each bank.

In the foregoing embodiments, the inter-cylinder variation abnormality is detected on the basis of the value itself of the total angular velocity difference Xᵢ. However, the inter-cylinder variation abnormality may be detected on the basis of a difference in the total angular velocity difference Xᵢ between a first time point at which the state can be regarded as being normal (e.g., at the time of shipment) and a second time point after the first time point. Concretely, it may be detected that the inter-cylinder variation abnormality has occurred, if the difference obtained by subtracting the total angular velocity difference Xᵢ at the first time point (e.g., −0.3 of the #1 cylinder shown in FIG. 7) from the total angular velocity difference Xᵢ at the second time point (e.g., −0.8 of the #1 cylinder shown in FIG. 7) is smaller than a negative abnormality determination value (e.g., −0.45) (i.e., is greater than the abnormality determination value in terms of absolute value). In this case, the value of the total angular velocity difference Xᵢ of each cylinder at the first time point is considered to vary from one engine to another; therefore, it is preferable that the value of the total angular velocity difference Xᵢ of each cylinder at the first time point be actually measured and be stored as learned values in the ECU 20.

Furthermore, the inter-cylinder air/fuel ratio variation abnormality detection apparatus for the multicylinder internal combustion engine may compare the second parameter of each cylinder with a predetermined criterion value, and, if there exists a value of the second parameter of a cylinder such that the revolution fluctuation of the cylinder is greater in fluctuation and slower in revolution than a value of the revolution fluctuation that corresponds to the criterion value, may detect the inter-cylinder air/fuel ratio variation abnormality, and may determine the cylinder that corresponds to the value of the second parameter as being the abnormal cylinder.

The inter-cylinder air/fuel ratio variation abnormality may be an inter-cylinder air/fuel ratio variation abnormality that occurs based on a rich deviation abnormality in which air/fuel ratio of one cylinder deviates to a rich side of a predetermined reference air/fuel ratio.

The inter-cylinder air/fuel ratio variation abnormality detection apparatus for the multicylinder internal combustion engine may set the criterion value according to load of the internal combustion engine.

The inter-cylinder air/fuel ratio variation abnormality detection apparatus for the multicylinder internal combustion engine may execute variation abnormality detection during execution of an air/fuel ratio feedback control whose target air/fuel ratio is a stoichiometric ratio.

The internal combustion engine may have at least three cylinders.

According to the inter-cylinder air/fuel ratio variation abnormality detection apparatus for a multicylinder internal combustion engine in accordance with the aspect of the invention, the rich deviation abnormality of a cylinder can be suitably detected by using a parameter that represents revolution fluctuation of each cylinder.

The embodiments of the invention are not limited to the foregoing embodiments, but the invention encompasses all modifications, applications and equivalents encompassed within the spirit of the invention defined by the appended claims. Therefore, the invention is not to be construed in any limited manner, but can be applied to any technology that belongs to the scope of spirit of the invention.

What is claimed is:

1. An inter-cylinder air/fuel ratio variation abnormality detection apparatus for a multicylinder internal combustion engine, comprising:
a first parameter detection portion that detects a first parameter that represents revolution fluctuation of a cylinder, with respect to each cylinder;
a second parameter calculation portion that calculates, with respect to an unspecified cylinder, a second parameter as a sum of the first parameters of the cylinders other than the unspecified cylinder, and that calculates the second parameter with respect to each cylinder; and
an abnormality determination portion that detects an inter-cylinder air/fuel ratio variation abnormality based on the second parameter of each cylinder, and that determines an abnormal cylinder that has the inter-cylinder air/fuel ratio variation abnormality.

2. The inter-cylinder air/fuel ratio variation abnormality detection apparatus according to claim 1, wherein
the second parameter of each cylinder is compared with a predetermined criterion value, and if there exists a value of the second parameter of a cylinder such that the revolution fluctuation of the cylinder is greater in fluctuation and slower in revolution than a value of the revolution fluctuation that corresponds to the criterion value, the abnormality determination portion detects the inter-cylinder air/fuel ratio variation abnormality, and determines the cylinder that corresponds to the value of the second parameter as being the abnormal cylinder.

3. The inter-cylinder air/fuel ratio variation abnormality detection apparatus according to claim 2, wherein
the inter-cylinder air/fuel ratio variation abnormality is an inter-cylinder air/fuel ratio variation abnormality that occurs based on a rich deviation abnormality in which air/fuel ratio of one cylinder deviates to a rich side of a predetermined reference air/fuel ratio.

4. The inter-cylinder air/fuel ratio variation abnormality detection apparatus according to claim 2, wherein
the criterion value is set according to load of the internal combustion engine.

5. The inter-cylinder air/fuel ratio variation abnormality detection apparatus according to claim 1, wherein
the abnormality determination portion executes inter-cylinder air/fuel ratio variation abnormality detection during execution of an air/fuel ratio feedback control whose target air/fuel ratio is a stoichiometric ratio.

6. The inter-cylinder air/fuel ratio variation abnormality detection apparatus according to claim 1, wherein the internal combustion engine has at least three cylinders.

7. An inter-cylinder air/fuel ratio variation abnormality detection method for a multicylinder internal combustion engine, comprising:
detecting a first parameter that represents revolution fluctuation of a cylinder of a plurality of cylinders of the engine, with respect to each cylinder;
calculating, with respect to an unspecified cylinder, a second parameter as a sum of the first parameters of the cylinders other than the unspecified cylinder, and calculating the second parameter with respect to each cylinder; and
detecting an inter-cylinder air/fuel ratio variation abnormality based on the second parameter of each cylinder, and determining an abnormal cylinder that has the inter-cylinder air/fuel ratio variation abnormality.
